(19) United States
(12) Patent Application Publication
(10) Pub. No.: US 2003/0102293 A1
(43) Pub. Date: Jun. 5, 2003

(54) Device for machining pieces with the aid of a laser beam

(76) Inventor: Marcel Therond, Rillieux La Pape (FR)

Correspondence Address: Ralph A. Dowell, Dowell & Dowell, P.C., Suite 309, 1215 Jefferson Davis Highway, Arlington, VA, 22202, US

(21) Appl. No.: 10/302,991

(22) Filed: Nov. 25, 2002

(30) Foreign Application Priority Data
Nov. 30, 2001 (FR) 01 15547

(51) Int. Cl. B23K 26/08

(52) U.S. Cl. 219/121.78

(57) ABSTRACT

This invention relates to a device for machining pieces with the aid of a laser beam, which comprises a laser adapted to emit a laser beam, a first reflecting mirror placed on the path of the emitted beam in order to reflect an intermediate beam, and a second reflecting mirror placed on the path of this intermediate beam, so as to direct a machining beam towards the pieces to be treated.

This device further comprises means for displacing these mirrors with respect to the chassis, such displacement means comprising at least one principal linear motor.

### FIELD OF THE INVENTION

The present invention relates to a device for machining pieces with the aid of a laser beam.

### BACKGROUND OF THE INVENTION

Machining is understood, within the meaning of the invention, as any operation consisting in directing a laser beam towards a piece, so as to treat the latter. The applications of marking, of engraving, of the fusion of materials such as for example powder, or of cutting out by means of such a laser beam, will be mentioned by way of non-limiting indication.

Such a machining device comprises, in known manner, a laser adapted to emit a beam, as well as first and second reflecting mirrors. The first of these mirrors is placed on the path of the beam emitted by the laser, so as to form an intermediate beam.

Furthermore, the second reflecting mirror, which is placed on the path of said intermediate beam, is adapted to create a machining beam capable of being directed towards the pieces to be treated. The orientation of these two mirrors may be modified, for example by employing rotary motors.

It is an object of the present invention to propose making a machining device of the afore-mentioned type, in which the positioning of the two mirrors can be modified in particularly flexible and easy manner.

It is another object to propose such a machining device which, while being sufficiently light, guarantees a precise positioning of these mirrors and is subjected, in service, to only slight frictions.

### SUMMARY OF THE INVENTION

To that end, the invention relates to a device for machining pieces with the aid of a laser beam, comprising a chassis, a laser adapted to emit a laser beam, first and second reflecting mirrors mounted on said chassis, the first reflecting mirror being adapted to be placed on the path of said emitted beam in order to reflect an intermediate beam, while the second reflecting mirror is adapted to be placed on the path of this intermediate beam so as to direct a machining beam towards the pieces to be treated, as well as means for displacing these mirrors with respect to the chassis, such displacement means comprising at least one principal linear motor.

### BRIEF DESCRIPTION OF THE DRAWINGS

The invention will be more readily understood on reading the following description given by way of non-limiting example with reference to the accompanying drawings, in which:

FIG. 1 is a view in perspective illustrating a machining device employing a laser beam, in accordance with a first form of embodiment of the invention.

FIG. 2 is a view in perspective illustrating a machining device in accordance with a second form of embodiment of the invention.

FIG. 2b is a view in perspective, on a larger scale, illustrating a detail of the machining device of FIG. 2.

FIG. 3 is a view in perspective, similar to FIG. 2, illustrating a machining device in accordance with a third form of embodiment of the invention.

FIG. 4 is a view in perspective illustrating the machining device shown in FIG. 2, associated with two work chambers, and

FIG. 5 is a side view, illustrating a machining device in accordance with a fourth form of embodiment of the invention.

### DESCRIPTION OF PREFERRED EMBODIMENTS

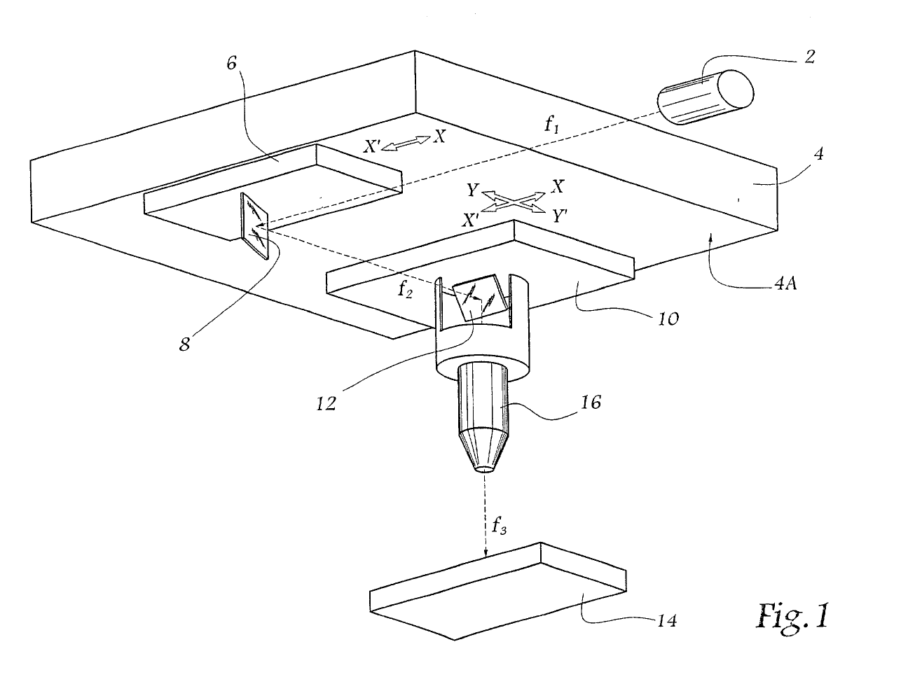

Referring now to the drawings, the machining device shown in FIG. 1 comprises a laser 2, for example of CO₂ or YAG type, which ensures the emission of a beam f₁. In the example illustrated, this beam is horizontal.

Furthermore, a chassis is provided (not shown), fitted with a bracket (likewise not shown), on which is mounted a fixed element 4, of substantially parallelepipedic shape. The latter cooperates with a first mobile element 6 which is capable of moving, in a single direction X-X′, in the vicinity of the lower face 4A of the fixed element 4.

As will be explained hereinbelow, the displacement of this mobile element 6 with respect to the fixed element 4 is effected by turning to account the phenomenon of induction. This mobile element 6 supports a first reflecting mirror 8 which is fixed thereto by any appropriate means.

In service, the beam f₁ moves in direction X-X′, which corresponds to the direction of displacement of the mobile element 6. The first mirror 8 reflects the emitted beam f₁, deflecting it for example by 90°, namely in the direction Y-Y′, while maintaining it in the horizonal plane. As a result, an intermediate beam designated by reference f₂ is obtained.

A second mobile element 10 is, furthermore, provided, adapted to move in the vicinity of the lower face 4A, in two directions perpendicular to each other. The first of these directions, X-X′, corresponds to that of the displacement of the mobile element 6, while the second of these directions is materialized by references Y-Y′.

As in the case of the first element 6, the displacement of the second mobile element 10 with respect to the fixed element 4 is effected by employing the phenomenon of induction.

A second reflecting mirror 12, fixed on the second mobile element 10, is interposed on the path of the intermediate beam f₂. This mirror 12 makes it possible to reflect this beam downwardly, this resulting in a machining beam f₃, adapted to be directed towards a piece 14 to be treated.

It should be noted that a focussing lens 16 is interposed on the path of the machining beam f₃. Such a measure allows this beam to be concentrated, which contributes to rendering it both narrower and more powerful. The piece 14 to be machined is advantageously placed in the focal plane of this lens 16, this ensuring efficient treatment thereof.

We will now come back to the fixed element 4, as well as to the two mobile elements 6 and 10.

This fixed inductor element 4, forming stator, and the mobile armature element 10, forming carriage, constitute a principal planar linear motor. They are for example in accordance with those described in French Patent No. 2 777 217, filed on Apr. 10, 1998, which is incorporated by reference in the present specification.

The mobile element 10 is thus made in the form of four modules, of which each comprises a coil and the magnetic core associated therewith. By varying the characteristics of the current in these different coils, it is possible to displace the carriage 10 in the two directions X-X′ and Y-Y′.

It should be noted that a passage of air (not shown) is formed in the body of the mobile element 10, which allows the formation, in service, of an air cushion between the opposite faces of the mobile element 10 and of the fixed element 4. Electrical supply of the coils is ensured, in known manner, by lines (not shown).

Similarly, the fixed element 4 and the mobile element 6 form another, secondary, planar linear motor, whose structure is similar to that of the principal motor described hereinabove.

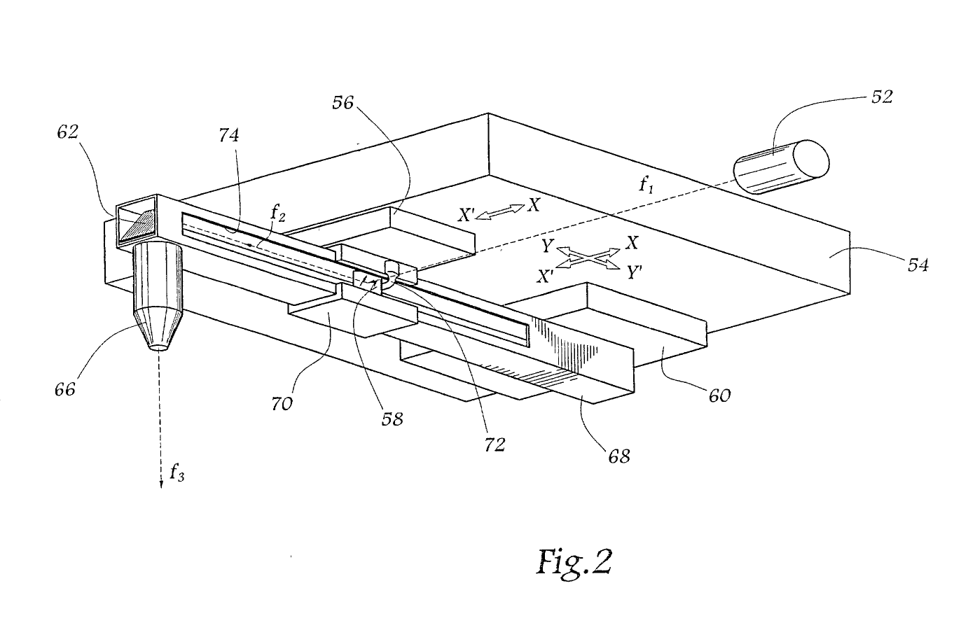

FIGS. 2 and 2b illustrate a first variant embodiment of the invention. In these Figures, the mechanical elements similar to those of FIG. 1 are given the same reference numerals, increased by 50. The principal carriage 60 supports an elongated tubular arm 68 extending in direction Y-Y′. This arm 68 penetrates in a guide clamp 70, mounted on the carriage 56.

The first reflecting mirror 58 is connected to the first mobile carriage 56. To that end, a bent rod 72 is provided, of which a first end is mounted on the lateral walls of the clamp 70, while its other end, which bears the mirror 58, is arranged inside the tubular arm 68.

The second reflecting mirror 62 is placed at the end of the arm 68 opposite the principal carriage 60. Consequently, this mirror 62 is fast, in translation, with the carriage 60. Furthermore, one of the lateral walls of this arm 68 has a longitudinal notch 74 made therein, intended for the passage of the laser beam f₁ emitted by the laser 52, as well as for the passage of the bent rod 72 supporting the mirror 58.

The machining device illustrated in these FIGS. 2 and 2b operates in similar manner to the device of FIG. 1.

The laser 52 thus directs the beam f₁, via the notch 74, towards the first mirror 58, which reflects the intermediate beam f₂ towards the second mirror 62. The latter then, with the interposition of the focussing lens 66, directs a machining beam f₃ downwardly.

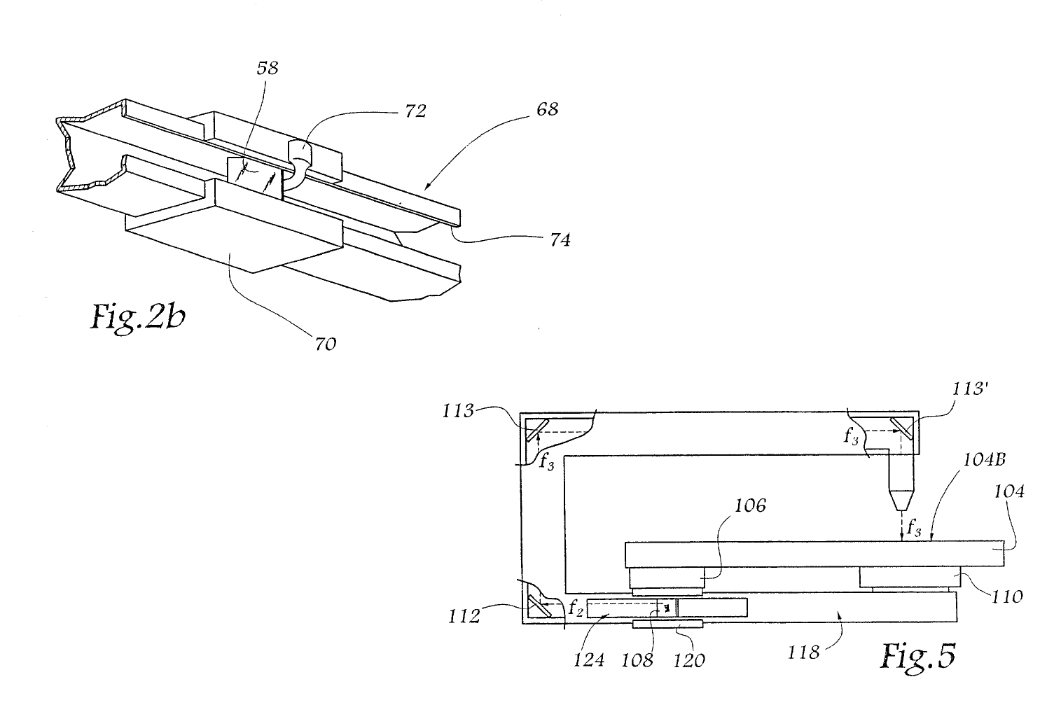

FIG. 3 illustrates a second variant embodiment of the invention. The machining device shown in this FIG. 3 differs from that of FIG. 2 in that the carriage 56′ is not motive, contrary to that, 56, of FIG. 2.

This passive carriage 56′ is thus mounted on a guide bar 76, fixed on two cheeks 78 fast with the fixed element 54. Consequently, the displacement of the carriage 56′ in direction X-X′, is imparted by the displacement of the principal mobile element 60, which is always motive.

The embodiments described with reference to FIGS. 2 and 3, employing an arm 68, present specific advantages.

In effect, they make it possible to reach pieces located offset with respect to the fixed element 4. Consequently, the zone where the piece to be marked is placed, is encumbered solely during the marking operation, the arm 68 being able to be withdrawn in direction Y-Y′, once this operation is terminated.

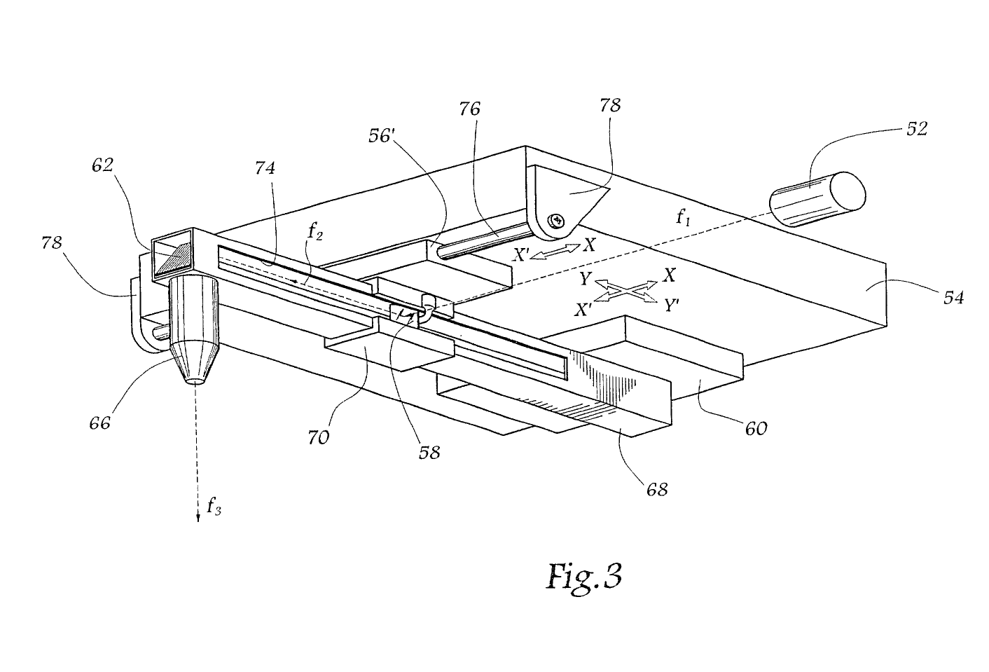

As shown in FIG. 4, the machining device of FIGS. 2 and 3, employing the arm 68, may be associated with two chambers 80, 80′, disposed side by side. Each chamber, which is light-impermeable, is provided with an upper door 82, 82′ as well as with a front trap 84, 84′.

In operation, one, 80, of the chambers is in service, in that the arm 68 penetrates therein so as to treat the pieces placed in this chamber. To that end, the trap 84 is open, while the access door 82 is closed.

During that time, the operator can access the inner volume of the other, 80′, of these chambers, in totally secure manner. To that end, the trap 84′ is closed, while the door 82′ is open. The operator is thus protected from any accidental reflection of the laser beam.

With a view to providing maximum security, it is possible to prevent opening of one of the doors 82, 82′ when the arm 68 is located in the corresponding chamber, for example automatically. The operator is thus protected from any unsuitable manoeuvres that he may make.

By way of additional variant (not shown), it may be envisaged to arrange the fixed element 54, as well as the mobile elements 56 or 56′, and 60, respectively, inside a casing.

In that case, the arm 58 then projects from the casing, being free to slide in its principal direction with respect to the support element disposed in an opening in the casing. Furthermore, this support element is adapted to move transversely with respect to the principal direction of the arm, while means are provided to maintain tightness of the casing, during displacement of this support element.

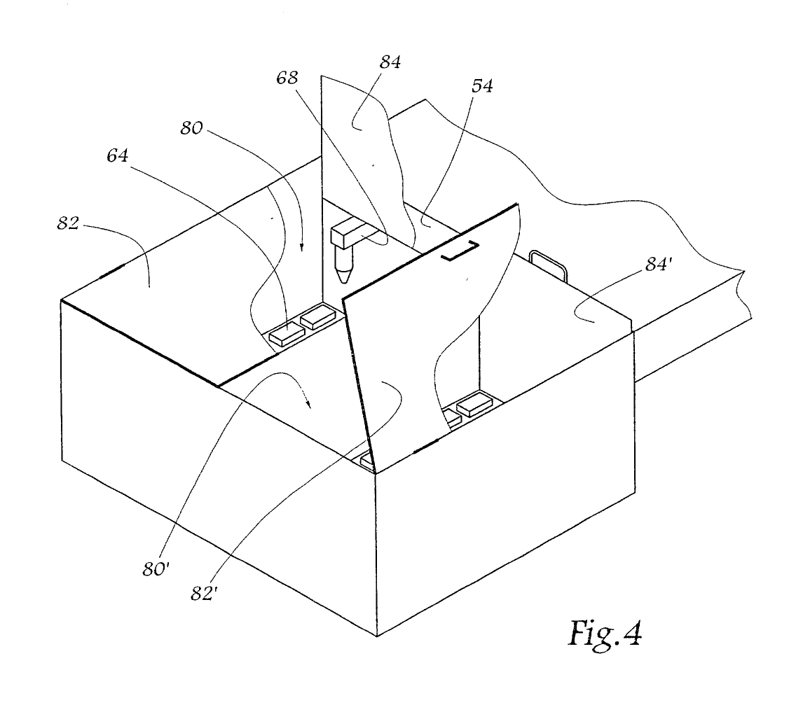

An arrangement of this type is illustrated in FIGS. 5 to 9 of aforementioned French Patent No. 2 777 217.

Finally, FIG. 5 illustrates a fourth variant embodiment of the invention. In this Figure, the mechanical elements similar to those of FIGS. 2 and 3 are given the same reference numerals, increased by 50.

The mobile carriage 110 of the machining device of this FIG. 5 supports an arm 118 presenting, when seen in side view, a substantially U shape. This arm 118 penetrates in a guide clamp 120 mounted on the mobile carriage 106. It should be noted that the latter may be motive, as in FIG. 2, or be driven passively by the principal carriage 110, as in the example of FIG. 3.

The second reflecting mirror 112 is oriented so as to direct the intermediate beam upwardly. Moreover, two additional mirrors 113, 113′ are provided, housed in the angles of the arm 118, which are adapted to reflect the machining beam f₃ towards the upper face 104B of the fixed element 104.

In service, the first mirror receives the beam (not shown) emitted by the laser, then directs the intermediate beam f₂ towards the mirror 112. The machining beam f₃ is then directed upwardly, in the direction of mirror 113, then horizontally in the direction of mirror 113′.

Finally, this mirror 113′ directs the machining beam f₃ downwardly, via the focussing lens 116. Consequently, it is possible to arrange the pieces to be treated on the upper face 104B of the fixed element 104, which thus performs a double function of motorization and of support of the pieces.

The invention is not limited to the examples described and shown.

The angular orientation of each mirror may, furthermore, be modified. Accordingly, this mirror is in that case mobile in rotation with respect to the arm or to the carriage which supports it.

The invention makes it possible to attain the objects set forth hereinabove.

In effect, it is possible to give the fixed inductor element considerable dimensions. Consequently, the mobile carriages are capable of moving over large surfaces, with the result that the positioning of the mirrors can be modified in particularly flexible manner.

In addition, the use of at least one linear motor makes it possible to employ a small number of constituent elements, which is advantageous, particularly in terms of functional clearances. Moreover, none of these constituent elements is capable of being deformed, in service, this giving the different mirrors a very precise positioning.

Finally, the use of such a linear motor ensures the existence of slight frictions thanks to the use of an air cushion interposed between the opposite faces of the inductor and the armature.

What is claimed is:

1. Device for machining pieces with the aid of a laser beam, comprising a chassis, a laser adapted to emit a laser beam, first and second reflecting mirrors, mounted on this chassis, the first reflecting mirror being adapted to be placed on the path of said emitted beam, in order to reflect an intermediate beam, while the second reflecting mirror is adapted to be placed on the path of this intermediate beam, so as to direct a machining beam towards the pieces to be treated, as well as means for displacing these mirrors with respect to the chassis, such displacement means comprising at least one principal linear motor.

2. The device of claim 1, wherein the principal linear motor comprises a fixed element, as well as a mobile element, adapted to be displaced with respect to this fixed element in two directions perpendicular to each other, at least one of the two reflecting mirrors being fast, at least in translation, with this mobile element, and in that alignment means are provided, allowing the intermediate beam to be directed, in service, towards the second reflecting mirror.

3. The device of claim 2, wherein the mobile element of the principal linear motor may be displaced, in service, in the direction of the intermediate beam, and in a direction perpendicular to that of the intermediate beam.

4. The device of claim 2, wherein the second reflecting mirror is fast, at least in translation, with the mobile element.

5. The device of claim 4, wherein the second mirror is mounted on the mobile element of the principal linear motor.

6. The device of claim 4, wherein the second mirror is mounted on an arm fast with the mobile element of the principal linear motor.

7. The device of claim 6, wherein the arm extends in one of the directions of displacement of the mobile element.

8. The device of claim 7, wherein the fixed element and the mobile element are disposed in a casing, the arm projecting out of the casing being free to slide in its principal direction with respect to a support element disposed in an opening of the casing, this support element being adapted to move transversely with respect to the principal direction of the arm, means being provided to maintain tightness of the casing during displacement of this support element.

9. The device of claim 7, wherein two adjacent light-impermeable chambers are provided, each of which is closed by a trap, these traps being adapted to be open alternately, in order to allow the passage of the arm towards a corresponding chamber.

10. The device of claim 9, wherein each chamber is provided with a door giving access to an operator.

11. The device of claim 6, wherein the arm presents a U shape, seen in side view, and in that at least one additional mirror is provided, allowing the machining beam to be directed towards an upper face of the fixed element.

12. The device of claims 2, wherein the alignment means comprise a secondary mobile element, on which is mounted the first reflecting mirror, this secondary mobile element belonging to a secondary linear motor.

13. The device of claim 10, wherein the fixed element of the secondary linear motor is merged with the fixed element of the principal linear motor.

14. The device of claims 6, wherein the first mirror is fast in translation with said arm, in the direction perpendicular to the principal direction of the arm.

15. The device of claim 1, wherein a focussing lens is provided, adapted to be interposed on the path of the machining beam.
